(19) United States
(12) Patent Application Publication
(10) Pub. No.: US 2026/0266132 A1
(43) Pub. Date: Sep. 10, 2026

(54) ROLL DOOR CURTAIN WITH GUIDE SLEEVE AND ROLL DOOR COMPRISING SAID ROLL DOOR CURTAIN

(71) Applicant: Assa Abloy Entrance Systems AB, Landskrona (SE)

(72) Inventor: Holger SIEWERT, Rheda-Wiedenbrueck (DE)

(21) Appl. No.: 19/164,830

(22) PCT Filed: Mar. 6, 2024
(86) PCT No.: PCT/EP2024/055871

§ 371 Date: Sep. 12, 2025

(30) Foreign Application Priority Data
Mar. 15, 2023 (SE) 2330126-0

(51) Int. Cl. E06B 9/58; E06B 9/70; E06B 9/80

(52) U.S. Cl. CPC E06B 9/58; E06B 9/80; E06B 9/70; E06B 2009/805

(57) ABSTRACT

The present invention relates to a roll door curtain 10, for a roll door system 1, to a roll door system and to a guide post assembly. The roll door curtain 10 being adapted to be rolled up and unrolled, and comprises a closing section 13, wherein the closing section closes a door opening 100 at least partially, when the roll door curtain 10 is unrolled and opens said door opening 100 when the roll door curtain 10 is rolled-up. Further, the roll door curtain comprises at least one guide sleeve for receiving at least one rigid guide post of the guide post assembly, wherein the guide sleeve slides along the guide post 42, 44, when the roll door curtain is rolled up and/or unrolled.

### FIELD OF THE INVENTION

The present invention relates to a roll door system, to a curtain for said system and to a guide post assembly for said system.

### BACKGROUND

Roll doors, also known as rolling doors or roller doors, are a type of door commonly used for industrial, commercial, and residential applications. Conventional roll doors close vertically (closing direction: up-down) or horizontally (closing direction: left-right).

Known roll doors comprise as a main component a curtain (e.g. connected slats or a flexible curtain). The slats or flexible curtains, are typically made of metal (such as steel or aluminum) or PVC. The slats are joined together by hinges, allowing the door to roll up and down as needed. Further a roll-up mechanism is provided, which allows the roll door to be rolled-up into a compact coil above/beneath a door opening, allowing for maximum use of the available space. The roll-up mechanism is typically powered by an electric motor, which can be controlled automatically, remotely and/or manually, e.g. by a wall-mounted switch.

Further, a roll door comprises lateral tracks or guides. Those are oftentimes extruded from a plastic material or aluminum or may be made of bent and cut sheet metal. For opening/closing, the roll door is guided along those tracks/guides that keep the slats/the curtain in place as they roll up and down.

These tracks and guides are typically attached to the wall opening e.g. a door frame or another building structure.

Further, roll doors can be equipped with weather seals to prevent drafts, moisture, and debris from entering the building. In order to withstand high wind loads, roll doors are oftentimes equipped with reinforcement straps or rods, which can be secured to a wall, if need be, leading to limited operationality.

However generally roll doors have only limited insulation, compared to other types of doors. This is, as the slats/the curtain is typically chosen thin, to allow for a space-saving up-rolling. Further known roll doors are vulnerability to damage. The rolling mechanism and thin slats/curtains of roll doors can make them more vulnerable to damage from impacts or extreme weather conditions, particularly wind loads. Even further, roll doors require regular maintenance to keep them functioning properly, and any damage to the rolling mechanism, guides/tracks and curtain/slats can be costly to repair.

It is therefore the object of the invention to provide an improved roll door curtain and a respective roll door system that overcomes the aforementioned drawbacks at least partially.

### SUMMARY

The object is achieved by a roll door curtain according to claim 1, a guide post assembly according to claim 9 and by a roll door system according to claim 15. Further aspects of the invention are given in the dependent claims and throughout the following description.

In particular, the object is achieved by a roll door curtain, for a roll door system, the roll door curtain being adapted to be rolled up and unrolled. The roll door curtain comprises a closing section, wherein the closing section closes a door opening at least partially, when the roll door curtain is at least partially unrolled and opens said door opening when the roll door curtain is rolled-up.

Hence, the roll door curtain can open and close the door opening, wherein the opening/closing direction may be vertically (up-down), horizontally (left-down) or any other direction. For closing the door opening, the roll door curtain is at least partially unrolled. Depending on the length of the roll door curtain and/or the degree of unrolling the roll door curtain, the door opening can be partially closed or fully closed.

Further, the roll door curtain is not limited in width or length. For example, the roll door curtain may be part of a passenger door, of a garage door, of a ware house door, of a hangar door and/or the like. Thus the door opening may be sized for passengers, cars, trucks, busses, planes and/or the like, depending on the intended use.

Further, the roll door curtain comprises at least one guide sleeve for receiving at least one rigid guide post, wherein the guide sleeve slides along the rigid guide post, when the roll door curtain is rolled up and/or unrolled.

Thus, the roll door curtain is guided exclusively by the internally arranged rigid guide post(s). Accordingly, external guide and/or support structures for guiding the roll door curtain and/or supporting the guide post(s) are not necessary and need not to be provided.

The at least one guide post is rigid (not flexible) and configured to guide the roll door curtain in the opening/closing direction without being deformed in a transverse direction. Transverse direction is perpendicular to a longitudinal axis of the guide post and may be lying in a plane, defined by the roll door curtain.

Even further, the at least one guide post is as rigid, that no lateral support structures along its length, at least in an area of the door opening, are required. Accordingly, the at least one guide post forms an independent support structure for the roll door curtain, which guides the roll door curtain in the opening/closing direction, and which is configured to absorb tensile forces acting in the transverse direction. These tensile forces are dissipated by the guide post without the need of any further lateral support structures, such as additional guide rails or tracks.

Accordingly, conventional guides/tracks of roll doors, which require a high degree of maintenance can be exchanged by guide posts, which can be received within guide sleeves of the roll door curtain. Further, the guide sleeves are easy to manufacture and typically no sliding blocks or other types of supports are required that are connected to the curtain and engage in common guides/tracks.

As the at least one guide sleeve is part of the curtain, it is possible to roll the guide sleeve together with the closing section of the curtain.

The guide sleeve may be part of the closing section or may form the closing section. In a particular aspect, the closing section of the roll door curtain (or at least a portion thereof) may be a double-layered curtain. The at least one guide sleeve may then be formed by the layers of the curtain. For example, a first curtain layer and a second curtain layer may form a single sleeve, receiving two guide posts being arranged on opposing sides of a door opening (e.g. to the left and to the right). The double-layered curtain allows for improved insulation and the thus formed sleeve for a facilitated set-up.

Further, the at least one guide sleeve may be provided laterally at the closing section or may be attached laterally at the closing section. In this aspect of the invention, the closing section may be formed by connected slats or a flexible curtain.

In case the closing section is formed by connected slats, the guide sleeve(s) can be laterally attached to respective ones of the slats. In case the closing section is formed by a flexible curtain, the at least one guide sleeve may be formed at a lateral area of the closing section by folding over the roll door curtain and securing the folded section. The folded section then can wrap the respective guide post(s). In another aspect, a separate guiding sleeve is provided that is attached to the roll door curtain, respectively the closing section thereof.

The securing may be done by any conventional manufacturing process, such as sewing, gluing, welding, riveting, and/or the like. Further, reversible connections may be used, such as velcro fasteners, zippers, buttons, push buttons, magnets, magnetic tapes, hooks and eyes, and/or the like.

Further, the at least one guide sleeve may be a seamless guide sleeve. A seamless guide sleeve may be circular knitted or extruded. Said seamless guide sleeve may form a double-layered closing section or may be attached to a closing section of a roll door curtain.

Further, the at least one guide sleeve may be made from a single sleeve part, wherein the single sleeve part is closed to form the guide sleeve; or the at least one guide sleeve may be composed of at least two sleeve parts, wherein the at least two sleeve parts are connected to form the guide sleeve. In the first aspect, two lateral edges of the single sleeve part may be secured to each other to form a guide sleeve. Said single-part guide sleeve may form a double-layered closing section or may be attached to a closing section of a roll door curtain.

In case two (or more) sleeve parts are connected to form the guide sleeve, those sleeve parts may be secured to one another, e.g. by a conventional manufacturing process, such as sewing, gluing, welding, riveting, and/or the like or by reversible connections (e.g. velcro fasteners, zippers, buttons, push buttons, magnets, magnetic tapes, hooks and eyes, and/or the like). Said multi-part guide sleeve may form a double-layered closing section or may be attached to a closing section of a roll door curtain.

At least one guide sleeve (e.g. a single-part guide sleeve and/or a multi-part guide sleeve) may comprise a closing edge, whereas the closing edge can be closed to form the guide sleeve. The closing edge may comprise at least one first connection element and at least one second, complementary connection element, wherein the first connection element and the second, complementary connection element can be reversible connected to close the closing edge.

In case of a single-part guide sleeve, a first connection element may be provided at a lateral edge of the sleeve part and the second, complementary connection element may be arranged further inwards. Thus, by folding over the lateral edge and by connecting the first and second connection elements, a guide sleeve can be formed. In case of a multi-part guide sleeve, a first connection element may be provided at a lateral edge of a first sleeve part and the second, complementary connection element may be provided at a lateral edge of a second sleeve part. By connecting the first and second connection elements, a guide sleeve can be formed.

The at least one first connection element and at least one second, complementary connection element may be velcro fasteners, zippers, buttons, push buttons, magnets, magnetic tapes, hooks and eyes, and/or the like. The reversible connection allows to open the sleeve if need be, e.g. for maintenance work. Further, initial installation of the roll door curtain is facilitated, as a respective guide post/guide posts can be inserted into the guide sleeve, when the sleeve being opened. Thus, the sleeve parts can be wrapped around the guide post(s) and connected to form the guide sleeve(s) when having received the guide post(s).

In a particular aspect, the at least one first connection element and at least one second, complementary connection element are self-closing. For example, the at least one first connection element and at least one second, complementary connection element may include magnets that close the connection, when first connection elements and second, complementary connection elements come in close proximity. Thus, damages of the curtain and the guide posts can be effectively prevented. In case e.g. a vehicle hits the door, the connection may open, thereby preventing the guide post(s) or curtain being damaged and close again, after the vehicle has left the door. Thus, the roll door is immediately operable again. In case the first connection elements and second, complementary connection elements do not come in close proximity after the hit on their own, the can be easily rearranged by a worker.

The roll door curtain may include a plastic foil, a non-woven and/or a fabric, wherein the roll door curtain may be a PVC curtain or may be PVC based curtain.

Further, at least one guide sleeve and/or a double layered portion of the closing section may be pressurized when the roll door curtain is in an unrolled or partially unrolled state. By pressurizing the guide sleeve, the sleeve may become stiff and provide for an improved stability of the door. Accordingly, a double layered portion of the closing section may be pressurized when the roll door curtain is in an unrolled or partially unrolled state. By pressurizing the double layered portion, the double layered portion may become stiff and provide for an improved stability of the door. For example, the entire closing section of the roll door curtain may be double layered. In this case, the roll door curtain can be inflated when being unrolled, thereby providing for an improved insulation. Further, only distinct portions of the roll door curtain may be double layered and/or adapted to be pressurized. Thus, the pressurizable portions may serve as stiffening element, when being pressurized (inflated).

By pressurizing the guide sleeve and/or a double layered portion of the closing section, particularly when being closed (or partially closed), the roll door curtain can withstand higher wind loads and an undesired or unauthorized opening can be prevented.

Even further, pressurizing can be done with tempered air and/or filling gas. When being warmed, the tempered air and/or filling gas may prevent icing of the roll door curtain and/or loss of energy. When being cooled the tempered air and/or filling gas may prevent undesired heating of cooling chambers being closed with said roll door curtain.

Even further, the pressurizing may be static or dynamic. If being static, the guide sleeve and/or a double layered portion of the closing section is inflated once when and/or during being unrolled and deflated prior and/or during being rolled-up again. Refilling is possible if the pressure should drop. If being dynamic, the air and/or filling gas is permanently or periodically supplied, to achieve a desired pressurization level within the pressurized guide sleeve and/or a double layered portion of the closing section.

Even further, the roll door curtain and particularly the closing section thereof may be reinforced with stiffening means, such as (metallic and/or polymeric) crossbars. Those crossbars may be attached to roll door curtain in a way that they can be rolled-up together with the roll door curtain (e.g. parallel to a rotational axis of a top roll of the roll door curtain). Those stiffening means may engage with the guide posts so as to enhance the stability of the roll door curtain when being unrolled.

Further the roll door curtain may comprise at least one window section (e.g. in form of a transparent or semitransparent foil portion) and/or a bottom profile. A bottom profile may be a horizontal bar that is adapted to connect the roll door curtain with a bottom of the door opening. The bottom profile helps to keep the door secure and prevent it from being lifted from the bottom. For example, the bottom profile may include locking means to lock the bottom profile with the bottom of the door opening. Further, the bottom profile may provide for a sealing between the curtain and the bottom of the door.

The object is further achieved by a guide post assembly for a roll door system. The guide post assembly comprising a first guide post and a second guide post. When being installed, the first and second guide posts frame a door opening. In a particular aspect, the guide posts are arranged on opposing sides of the door opening (e.g. to the left and to the right).

The guide posts are rigid guide posts, that are configured to guide the unrolling and up-rolling of the roll door curtain exclusively from the inner of the guide sleeve or respective guide sleeves.

As the guide posits are rigid, they get not deformed in a transverse direction while guiding the roll door curtain. Hence, no external guide and/or support structures for guiding the roll door curtain and/or supporting the guide post(s) are required.

Particularly, the at least one guide post is as rigid, that no lateral support structures along its length, at least in an area of the door opening, are required. Accordingly, the at least one guide post forms an independent support structure for the roll door curtain, which guides the roll door curtain in the opening/closing direction, and which is configured to absorb tensile forces acting in the transverse direction. These tensile forces are dissipated by the guide post(s) without the need of any further lateral support structures, such as additional guides or tracks.

Those guide posts are adapted to be received in a guide sleeve or respective guide sleeves of a roll door curtain as outlined above. They guide the unrolling and up-rolling of the roll door curtain. Each guide post may be received in an assigned guide sleeve of the roll door curtain, allowing to provide a single-layer curtain (or a double-layer curtain) between the posts, or both guide posts may be received in a single guide sleeve. Thus, the closing section of the roll door curtain is at least double-layered.

In an aspect, the first guide post and the second guide post may be interconnected with a guide beam. The guide beam may be arranged above the door opening and stabilizes the guide post assembly. For guiding the roll door curtain, the guide beam may be received within the guide sleeve.

Further, the guide post assembly may include at least one guide tip. The guide tip may be arranged on a free end of a guide post or at the guide beam. The guide tip is adapted to facilitate inserting the guide post in an assigned guide sleeve. For example, the guide tip may have a conical or wedged shape. It may be integrally formed with the guide post(s) or the guide beam or may be a separate part attached to the guide post/guide beam.

The guide posts may be steel posts, aluminum posts or plastic-based posts. For example, a plastic-based post may be reinforced (e.g. with carbon fibers). The material of the guide posts is chosen to provide for sufficient rigidity, particularly flexural rigidity. Further, the cross sectional profile of the guide posts may be chosen, so as to further improve the flexural rigidity. Thus, the roll door curtain can be guided exclusively by the internally arranged guide post(s) and external structures are not necessary.

In a particular aspect, the posts may be made of a material or may be covered by a material that reduces the friction between the guide sleeve and the guide post. This material may be chosen from the group of PFTE (Polytetrafluoroethylene), UHMWPE (Ultra-High Molecular Weight Polyethylene), Polyoxymethylene, Nylon, PEEK (Polyether Ether Ketone), and/or the like. Depending on the intended use, the roll door curtain may reach door speeds of up to 1 m/s, of up to 2 m/s, of up to 2.6 m/s, or even of up to 3 m/s.

Further, the first guide post and/or the second guide post may include at least one (or multiple) sliding rib(s) and/or guiding rollers. The sliding ribs may be distributed circumferentially around the respective guide post thereby minimizing the contact surface between the guide sleeve and the guide post. Hence, friction can be reduced and the sliding can be improved. Further, for improving the sliding, the first guide post and/or the second guide post may include guiding rollers, which guiding rollers may be cylindrical, conical, spherical and/or otherwise shaped. The guiding rollers support the sliding of the guide sleeve along the respective guide post and may be distributed at the guide post in longitudinal and/or circumferential direction.

Further, at least one of the guide posts may include at least one air-outlet hole, the at least one air-outlet hole serves to establish an air layer between the guide post and an assigned guide sleeve. The air layer further improves the sliding, allowing for higher opening/closing speeds.

Further, the first guide post and/or the second guide post may be supported by a flexible element, such as a spring (e.g. a spiral spring), a rubber block, and/or the like. The flexible support reduces the risk of damaging the posts during use. If e.g. a vehicle hits or touches the post, the post can be deflected and reflected after the vehicle has left the spot. Thus, damages such as deforming the post can be prevented.

Even further, the first guide post and/or the second guide post may be supported at a free end thereof with at least one first support roll. The at least one support roll may be arranged between the wall and the respective guide post, thereby sandwiching a portion of the guide sleeve between the support roll and the respective guide post. Thus, the maximum allowable deflection in a direction towards the wall of the guide post can be adjusted, while allowing the roll door curtain to be unrolled/rolled-up. In another aspect, the at least one first support roll may be arranged so as to adjust the maximum allowable deflection in a direction away from the wall of the guide post.

Further at least one second support roll may be provided. Said second support roll may be arranged opposite to the first support roll, so as to support the guide post on the opposing side. Thus, the maximum allowable deflection of the guide trictec post in a direction towards the wall and in a direction away from the wall can be adjusted.

The object is further achieved by a roll door system comprising a roll door curtain and a guide post assembly as outlined above. Further, the roll door system may comprise a top roll or a side roll for rolling up and unrolling the roll door curtain.

The top roll or a side roll may be attached with respective brackets on a wall or ceiling. Further, the top roll or a side roll may be actuated, e.g. by an electric drive. Said electric drive may be connected via a shaft and/or a gearing with a shaft of the roll. In a further aspect, the drive may be integrated in the shaft of the roll or may form the shaft of the roll e.g. as external rotor electric motor.

Further the system may comprise at least one brake. The brake being adapted to secure the roll door curtain in a desired position. For example, the brake may tighten the curtain, e.g. by pushing apart the guide posts or by extending a brake member, thereby tensioning the roll door curtain. Thus, the curtain may be able to withstand higher wind loads.

The roll door system may further comprise at least one sealing means, such as a brush strip or a sealing lip. The sealing means may at least partially surround the door opening (e.g. on the left and right side only, or on the left side, top and right side) and may seal a gap between a wall and the roll door curtain.

Further, the roll door system may comprise a roll door safety means for surveilling at least a passage area. The passage area is an area in close vicinity to the roll door, in which when being entered by e.g. a person or a vehicle, a collision with roll door curtain may occur.

The roll door safety means may include at least one of the following:
A safety edge: These may be pressure-sensitive strips or pads that are installed e.g. on a bottom edge of the curtain (or a slat thereof) or on the bottom profile. If the roll door curtain comes into contact with an obstruction, the safety edge will trigger a switch that will stop the roll door curtain from closing or reverse its direction.
A photoelectric sensor: These sensor(s) may use infrared or laser beams (e.g. a light grid) to detect the presence of objects in the roll door curtain's path. The object(s) to be detected may include external objects, such as persons or vehicles. If such an object is detected, the roll door curtain will be stopped or reversed. The photoelectric sensor(s) may be included in the first and/or second guide posts.

Further, the roll door safety means may be able to detect a position, speed and/or acceleration of the roll door curtain, so as to determine whether a collision with a detected object being in the passage area or being about to enter the passage area is likely or not. Depending on the determination step, the roll door curtain can e.g. be stopped and/or reversed.

### BRIEF DESCRIPTION OF THE FIGURES

The present disclosure will be more readily appreciated by reference to the following detailed description when being considered in connection with the accompanying drawings in which:

FIG. 1A shows a schematic front view of a roll door system, the door being opened;

FIG. 1B shows a schematic side view of a roll door system, the door being opened;

FIG. 2A shows a schematic front view of a roll door system, the door being closed;

FIG. 2B shows a schematic side view of a roll door system, the door being closed;

FIG. 3 shows a schematic cut view of a roll door system;

FIG. 4 shows a schematic cut view of a further roll door system;

FIGS. 5A-H show different guide sleeves;

FIG. 6 shows a schematic front view of guide post assembly of a roll door system, and

FIG. 7 shows a detailed view of a guide post of a roll door system.

### DETAILED DESCRIPTION OF THE FIGURES

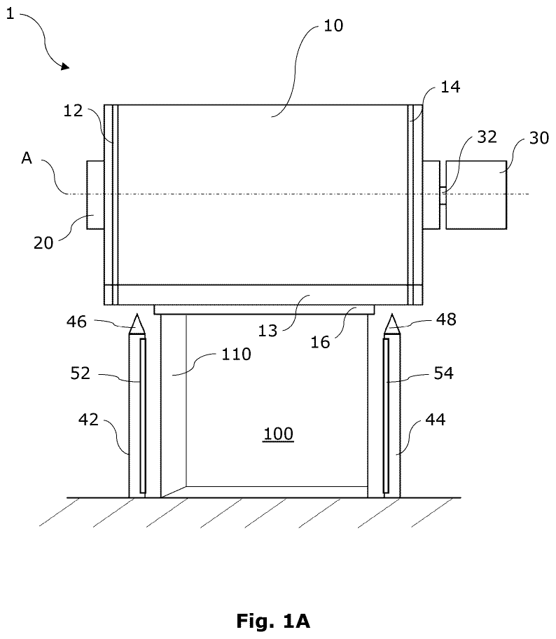

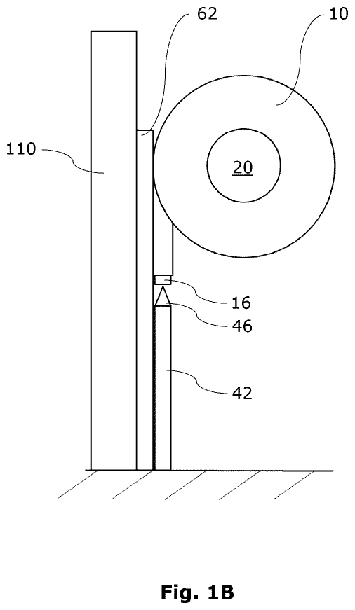

FIGS. 1A to 2B show a roll door system 1 in different perspectives and opening states. While FIGS. 1A and 1B show the system 1 in an open state, FIGS. 2A and 2B show a closed door. Particularly, FIG. 1A shows a schematic front view of the roll door system 1, the door being opened. FIG. 1B shows a schematic side view of a roll door system 1, of FIG. 1A. FIG. 2A shows a schematic front view of the roll door system 1, the door being closed and FIG. 2B shows a schematic side view of a roll door system 1, the door being closed.

The roll door system 1 comprises a roll door curtain 10 and a top roll 20 for rolling up and unrolling the roll door curtain 10. The top roll 20 is attached to a wall 110 with brackets (not shown) above a door opening 100. It has to be noted that the figures are only schematically. The size ratio of the top roll 20 to the door opening 100 should be understood as exemplary only and in no way limiting. It is possible, for example, that the top roll 20 has a significantly smaller and/or larger diameter in relation to the door opening 100 than shown in the figures.

The top roll 20 is an actuated top roll, i.e. the top roll 20 is driven by an actuator 30, such as electric drive. Said electric drive may be connected via a shaft 32 and/or a gearing with a shaft of the top roll 20. When being actuated, the top roll 20 rotates around axis A.

Depending on the direction of rotation, the roll door curtain 10 is unrolled and a closing section 13 of the roll door curtain 10 closes the door opening 100 at least partially (cf. FIGS. 2A and 2B) In case the direction of rotation is reversed, the roll door curtain 10 is rolled up and the door opens (again), cf. FIGS. 1A, 1B.

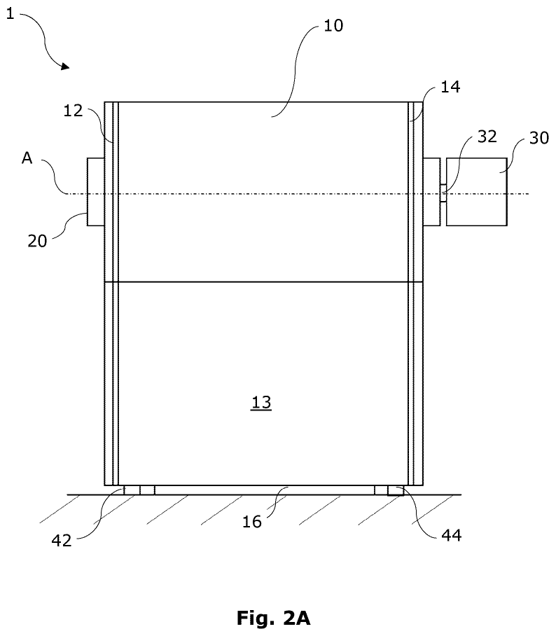

The lateral edges of the roll door curtain 10, are provided as closing edges 12, 14. As best shown in FIG. 3 each closing edge 12, 14 has a first connection element 12a, 14a and a one second, complementary connection element 12b, 14b, wherein the first connection elements 12a, 14a and the second, complementary connection elements 12b, 14b can be reversible connected to close the closing edge. Thereby a guide sleeve 15 is formed. This guide sleeve forms the closing portion 13 and receives guide posts 42, 44 of guide post assembly 40.

The first guide post 42 and the second guide post 44 frame the door opening 100. As the first and second guide posts 42, 44 are adapted to be received in the guide sleeve 15 (cf. FIGS. 2A to 3) of the roll door curtain 10 the unrolling and up-rolling of the roll door curtain is guided.

For facilitating the insertion of the guide posts in the guide sleeve 15, a conical guide tip 46, 48 is arranged on a free end of the guide post 42, 44, respectively.

As shown in FIGS. 1A to 2B, the guide posts 42, 44 are rigid guide posts, which guide the roll door curtain 10 exclusively. Hence, no external guiding structures, such as guide rails or tracks are required.

Further, the roll door system 1 comprising a roll door safety means 52, 54 for surveilling the roll door curtain 10. Here, the roll door safety means 52, 54 includes a light grid. Each post 42, 44 includes a respective safety means 52, 54, such as an IR-emitter or an IR receiver.

A bottom profile 16 may be provided on a bottom edge of the roll door curtain 10, that serves for keeping the door secure and prevent the curtain from being lifted from the bottom.

FIG. 3 shows a schematic cut view of the roll door system 1. Here, the curtain 10 is a double-layered curtain that allows for improved insulation. The curtain 10 comprises a first sleeve part 10a (also denoted as first curtain layer) and a second sleeve part 10b (also denoted as second curtain layer). Both sleeve parts 10a, 10b form the guide sleeve 15. Said guide sleeve 15 forms the closing section 13 of the curtain 10. Particularly, the first curtain layer 10a and a second curtain layer 10b form a single sleeve 15, which sleeve 15 receives both guide posts 42, 44.

Each closing edge 12, 14 has a first connection element 12a, 14a, such as a magnetic strip, and a second, complementary connection element 12b, 14b, which may also be a magnetic strip. Hence, the first connection elements 12a, 14a and the second, complementary connection elements 12b, 14b may be self-closing. I.e., when being in close proximity, the connection elements 12a, 12b, 14a, 14b reversibly connect with each other, thereby forming a guiding sleeve 15.

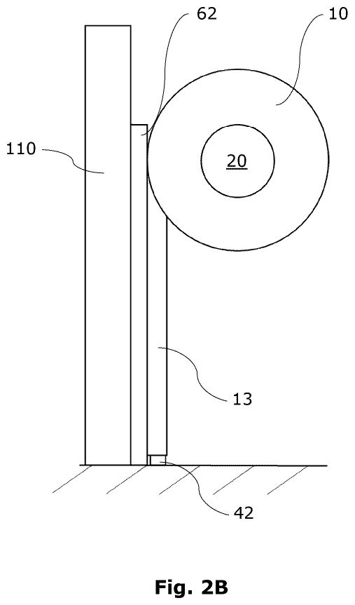

FIG. 4 shows a schematic cut view of a further roll door system. Instead of a single guide sleeve, two separate guide sleeves 15a, 15b are provided. Each guide sleeve 15a, 15b, receives a respective one of the guide posts 42, 44. For forming the guide sleeves, lateral edges 12, 14 of respective sleeve parts may be connected using first connection elements 12a, 14a and the second, complementary connection elements 12b, 14b, as described above. The guide sleeves 15a, 15b may be provided laterally at the closing section 13 (they may be integrally formed) or attached laterally at the closing section 13 (e.g. by sewing, welding, gluing and/or the like). In FIG. 4, the closing section 13 is a single-layered closing section 13. It is to be understood, that the single-layered setup is only exemplary and that likewise a double-layered (or a further multi-layered, such as a three layered) curtain 10′ may be provided.

As best seen in FIGS. 3 and 4, the roll door system 1 may include sealing means 62, 64, such as brush strips. These sealing means 62, 64 may at least partially surround the door opening 100 and thereby seal a gap between the wall 110 and the roll door curtain 10, 10′.

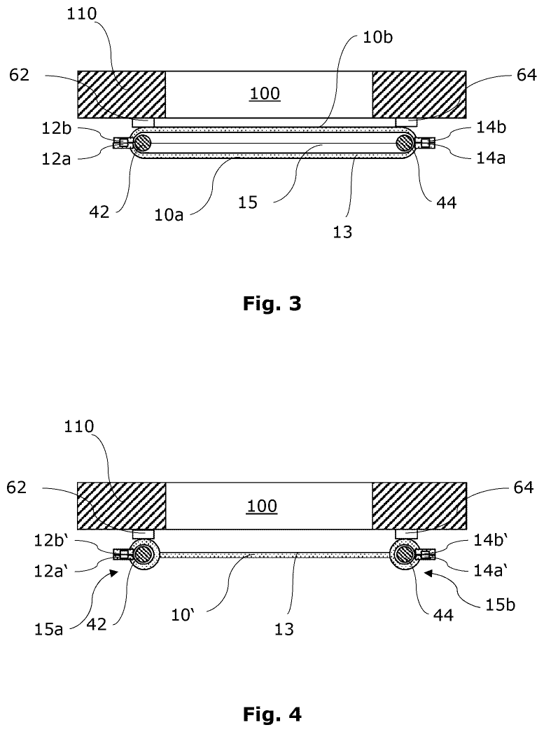

FIGS. 5A-H show different guide sleeves. In FIGS. 5A to 5D guide sleeves 15 are shown, that receive two guide posts, i.e. guide posits 42 and 44. The roll door curtain 10 is a double layered curtain.

In FIG. 5A, a seamless guide sleeves 15 is provided. Said guide sleeve may be extruded or circularly knitted. In FIG. 5B, the guide sleeve is a single-part guide sleeve. By forming the curtain 10 in a sleeve form and by connecting the overlapping lateral edges 10c, the sleeve is formed. FIG. 5C shows also a single-part guide sleeve. Here, the lateral edges of the curtain 10 are placed on top of each other so that a lateral protrusion 10d is formed. In the area of the lateral portion, the edges can be connected to form the sleeve 15. FIG. 5D shows the sleeve 15 in the configuration of FIG. 3. Here, two lateral protru-sions are formed by the first sleeve part 10a and the second sleeve part 10b. The first and second sleeve parts 10a, 10b, may be connected using first and second connection elements 12a, 12b, 14a, 14b (cf. FIG. 3).

In FIGS. 5E to 5H curtains 10′ with separate guide sleeves 15a, 15b are shown. The portion of the curtain 10′ that connects the sleeves 15a, 15b may be single layered (as shown) or multi-layered (at least double layered). Further, the portion of the curtain 10′ that connects the sleeves 15a, 15b may be formed by slats, that are hinged to form a closing section. Said slats may then be attached to the sleeves 15a, 15b.

In FIG. 5E, the guide sleeves 15a, 15b are formed as seamless guide sleeves, attached to or integrally formed with the curtain 10′. In FIG. 5F, the guide sleeves 15a, 15b are formed by folding over respective lateral edges of the curtain 10a′, 10b′ and connecting the latter to the curtain 10′. In FIG. 5G, the guide sleeves 15a, 15b are formed as the sleeve shown in FIG. 5B. These guide sleeves may then be connected to the curtain 10′. In FIG. 5H, the guide sleeves 15a, 15b are formed as the sleeve shown in FIG. 5C. These guide sleeves may then be connected to the curtain 10′.

For connecting the lateral edges/sleeve parts, first connection elements and second, complementary connection elements may be used to form a reversible connection. Alternatively, the connection may be a permanent connection, e.g. sewed, welded, glued, and/or the like.

It is to be understood that the above guide sleeves give only some embodiments of the present invention and shall not be understood limiting as there are further ways to form a guide sleeve.

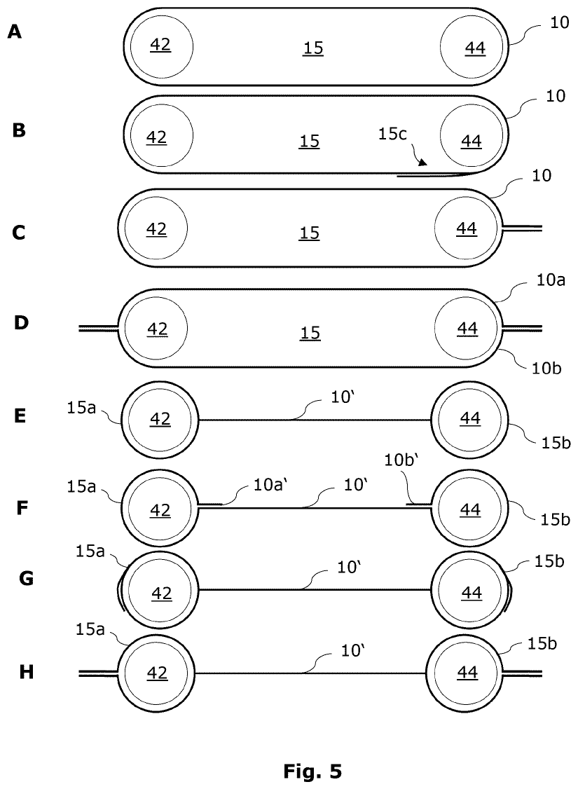

FIG. 6 shows a schematic front view of a guide post assembly 40. The guide post assembly 40 including a first guide post 42′ and a second guide post 44′. The guide posts 42′, 44′ are provide for a high lateral rigidity and are interconnected and stabilized with a guide beam 43′. This guide post assembly 40 may be received in a guide sleeve (as e.g. shown in any of FIGS. 5A to 5D) for guiding the movement of a roll door curtain.

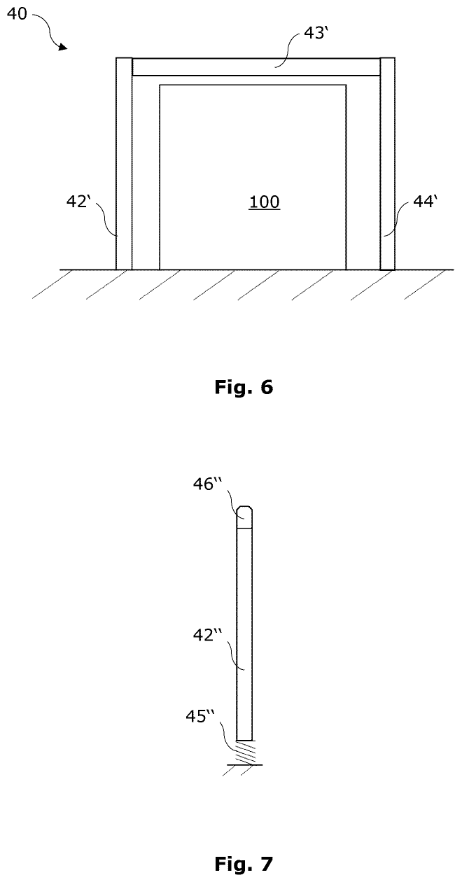

FIG. 7 shows a detailed view of a guide post 42″ of a roll door system. The guide post 42″ is supported by a flexible element 45″. Due to the flexible element 45″ (here a spring) the guide post can be deflected and reflected. Hence, it is less prone to damages. Further, the guide post 42″ is rigid and is provided with a guide tip 46″ that facilitates inserting the guide post in a respective guide sleeve (as e.g. shown in any one of FIGS. 5A to 5H).

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

### LIST OF REFERENCE SIGNS

1 roll door system
10 roll door curtain
10a sleeve part (first curtain layer)
10b sleeve part (second curtain layer)
10c overlapping edges
10d lateral protrusion
10′ roll door curtain
10a′ lateral edge
10b′ lateral edge
12 closing edge
12a first connection element
12b second, complementary connection element
12a′ first connection element
12b′ second, complementary connection element
14 closing edge
14a first connection element
14b second, complementary connection element
14a′ first connection element
14b′ second, complementary connection element
15 guide sleeve
15a guide sleeve
15b guide sleeve
16 bottom profile
20 top roll
30 actuator
32 shaft
40 guide post assembly
42 first guide post
42′ first guide post
42″ first guide post
43′ guide beam
44 second guide post
44′ second guide post
45′ flexible element (e.g. a spiral spring)
46 guide tip
46′ guide tip
48 guide tip
52 safety means (e.g. a light grid)
54 safety means (e.g. a light grid)
62 sealing means (e.g. a brush strip)
64 sealing means (e.g. a brush strip)
100 opening
110 wall
A axis of rotation

1. A roll door curtain (10), for a roll door system (1), the roll door curtain (10) being adapted to be rolled up and unrolled, the roll door curtain (10) comprising:
a closing section (13), wherein the closing section closes a door opening (100) at least partially, when the roll door curtain (10) is at least partially unrolled and opens said door opening (100) when the roll door curtain (10) is rolled-up; and
at least one guide sleeve (15; 15a, 15b) for receiving at least one rigid guide post (42, 44), wherein the guide sleeve (15; 15a, 15b) slides along the rigid guide post (42, 44), when the roll door curtain is rolled up and/or unrolled, so as to be guided internally exclusively by the at least one received guide post (42, 44).

2. The roll door curtain (10), according to claim 1, wherein the guide sleeve (15) is part of the closing section (13) or forms the closing section (13), or wherein at least one guide sleeve (15a, 15b) is provided laterally at the closing section (13) or attached laterally at the closing section (13).

3. The roll door curtain (10), according to claim 1, wherein the at least one guide sleeve (15; 15a, 15b) is a seamless guide sleeve, or
made from a single sleeve part, wherein the single sleeve part is closed to form the guide sleeve; or
composed of at least two sleeve parts (10a, 10b), wherein the at least two sleeve parts are connected to form the guide sleeve (15).

4. The roll door curtain (10), according to claim 1, wherein the at least one guide sleeve (15; 15a, 15b) comprises a closing edge (12, 14), whereas the closing edge (12, 14) can be closed to form the guide sleeve (15; 15a, 15b), the closing edge (12, 14) further comprising
at least one first connection element (12a, 14a) and at least one second, complementary connection element (12b, 14b), wherein the first connection element and the second, complementary connection element can be reversible connected to close the closing edge.

5. The roll door curtain (10), according to claim 4, wherein the at least one first connection element (12a, 14a) and at least one second, complementary connection element (12b, 14b) are self-closing.

6. The roll door curtain (10), according to claim 1, wherein the roll door curtain (10) includes a plastic foil, a non-woven and/or a fabric, wherein the roll door curtain may be a PVC curtain or may be PVC based curtain.

7. The roll door curtain (10), according to claim 1, wherein the at least one guide sleeve (15; 15a, 15b) and/or a double layered portion of the closing section may be pressurized when the roll door curtain (10) is in an unrolled or partially unrolled state; and/or wherein the roll door curtain may be reinforced with stiffening means, such as crossbars.

8. The roll door curtain (10), according to claim 1, further comprising at least one window section and/or a bottom profile (16).

9. A guide post assembly (40) for a roll door system (1), the guide post assembly (40) comprising
a first guide post (42, 42′, 42″), and
a second guide post (44, 44′), wherein the first and second guide posts (42, 42′, 42″, 44, 44′) are rigid guide posts that frame a door opening (100);
wherein the first and second guide posts (42, 42′, 42″, 44, 44′) comprise the at least one rigid post adapted to be received in the at least one guide sleeve (15) or respective guide sleeves (15a, 15b) of the roll door curtain (10), according to claim 1, for guiding the unrolling and up-rolling of the roll door curtain (10) exclusively from the inner of the guide sleeve (15) or respective guide sleeves (15a, 15b).

10. The guide post assembly (40) according to claim 9, wherein the first guide post (42′) and the second guide post (44′) are interconnected with a guide beam (43′).

11. The guide post assembly (40) according to claim 10, further comprising at least one guide tip (46, 48, 46″), the guide tip (46, 48, 46″) being arranged on a free end of the first or second a guide post (42, 44, 42″) or at the guide beam (43′), wherein
the guide tip (46, 48, 46″) is adapted to facilitate inserting the first or second guide post (42, 44) in an assigned guide sleeve (15, 15a, 15b).

12. The guide post assembly (40) according to claim 9, wherein at least one of the guide posts (42, 44, 42″, 44, 44′) includes at least one air-outlet hole, the at least one air-outlet hole serving to establish an air layer between the at least one guide post (42, 44, 42″, 44, 44′) and an assigned guide sleeve (15, 15a, 15b).

13. The guide post assembly (40) according to claim 9, wherein the first guide post (42) and/or the second guide post (44) includes at least one sliding rib and/or a guiding rollers.

14. The guide post assembly (40) according to claim 9, wherein the first guide post (42″) and/or the second guide post is supported by a flexible element (45″), and/or wherein the first guide post and/or the second guide post is supported at a free end thereof with at least one first support roll and/or an opposing second support roll.

15. A roll door system (1) comprising
the roll door curtain (10) according to claim 1,
a top or side roll (20) for rolling up and unrolling the roll door curtain (10), and a guide post assembly (40), wherein the guide post assembly comprises:
a first guide post, and
a second guide post, wherein the first and second guide posts are rigid guide posts that frame the door opening;
wherein the first and second guide posts are adapted to be received in the at least one guide sleeve or respective guide sleeves of the roll door curtain, for guiding the unrolling and up-rolling of the roll door curtain exclusively from the inner of the at least one guide sleeve or the respective guide sleeves.

16. The roll door system (1) according to claim 15, further comprising at least one brake, the brake being adapted to secure the roll curtain (10) in a desired position.

17. The roll door system (1) according to claim 15, further comprising at least one sealing means (62), the sealing means (62) at least partially surrounding the door opening (100) and being adapted to seal a gap between a wall (110) and the roll door curtain (10).

18. The roll door system (1) according to claim 15, further comprising a roll door safety means (52, 54) for surveilling at least a passage area.
